(19) United States
(12) Patent Application Publication
(10) Pub. No.: US 2007/0127578 A1
(43) Pub. Date: Jun. 7, 2007

(54) Low delay and small memory footprint picture buffering

(76) Inventors: Dijia Wu, Shanghai (CN); Jia Bao, Shanghai (CN); Shaolin Wu, Shanghai (CN)

Correspondence Address: KACVINSKY LLC;C/O INTELLEVATE, P.O. BOX 52050, MINNEAPOLIS, MN, 55402, US

(21) Appl. No.: 11/292,569

(22) Filed: Dec. 2, 2005

(51) Int. Cl. H04N 11/02; H04N 7/12

(52) U.S. Cl. 375/240.25; 375/240.26

(57) ABSTRACT

Techniques for low delay and small memory footprint picture buffering are described. For example, an apparatus may include a media processing node to receive a decoded video frame. The media processing node may selectively output and selectively buffer the decoded video frame. Other embodiments are described and claimed.

### BACKGROUND

One international video coding standard is the H.264/MPEG-4 Advanced Video Coding (AVC) standard jointly developed and promulgated by the Video Coding Experts Group of the International Telecommunications Union (ITU) and the Motion Picture Experts Group (MPEG) of the International Organization for Standardization and the International Electrotechnical Commission. The AVC H.264/MPEG-4 AVC standard provides coding for a wide variety of applications including video telephony, video conferencing, television, streaming video, digital video authoring, and other video applications. The standard further provides coding for storage applications for the above noted video applications including hard disk and DVD storage.

### BRIEF DESCRIPTION OF THE DRAWINGS

FIG. 1 illustrates one embodiment of a media processing system.

FIG. 2 illustrates one embodiment of a media processing sub-system.

FIG. 3 illustrates one embodiment of a first logic flow.

FIG. 4 illustrates one embodiment of a second logic flow.

### DETAILED DESCRIPTION

Various embodiments may be generally directed to a low delay, small memory footprint approach to decoded picture buffering. Reference will now be made in detail to a description of these embodiments as illustrated in the drawings. While the embodiments may be described in connection with these drawings, there is no intent to limit them to drawings disclosed herein. On the contrary, the intent is to cover all alternatives, modifications, and equivalents within the scope of the described embodiments as defined by the accompanying claims.

Various embodiments may be generally directed to various standards, such as an H.264-compliant decoding standard, for example. One embodiment, for example, selectively outputs and selectively buffers a decoded video frame compared to the H.264 decoding standard. In particular, when the picture order count (POC) type for a decoded picture frame equals two, the decoding order (e.g., frame number) of each picture is proportional to its display order. For such an instance, a decoded frame may be output immediately after it has been decoded and may only be stored in a buffer if it is referenced by following frames. Such an arrangement decreases both the delay in outputting a frame and the memory required for the buffer. Accordingly, a decoder operating according to an embodiment may exhibit improved performance. For example, for a given CPU capacity as measured in megahertz (MHz), the frame rate may be increased due to a reduced memory access penalty by efficient use of a faster on-chip memory resource. The embodiments are not limited in this context.

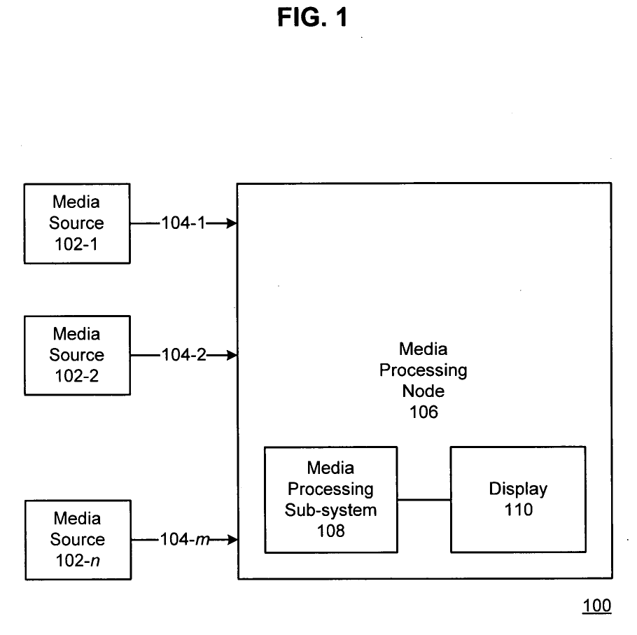

FIG. 1 illustrates one embodiment of a system. FIG. 1 illustrates a block diagram of a system 100. In one embodiment, for example, system 100 may comprise a media processing system having multiple nodes. A node may comprise any physical or logical entity for processing and/or communicating information in the system 100 and may be implemented as hardware, software, or any combination thereof, as desired for a given set of design parameters or performance constraints. Although FIG. 1 is shown with a limited number of nodes in a certain topology, it may be appreciated that system 100 may include more or less nodes in any type of topology as desired for a given implementation. The embodiments are not limited in this context.

In various embodiments, a node may comprise, or be implemented as, a computer system, a computer sub-system, a computer, an appliance, a workstation, a terminal, a server, a personal computer (PC), a laptop, an ultra-laptop, a handheld computer, a personal digital assistant (PDA), a set top box (STB), a telephone, a mobile telephone, a cellular telephone, a handset, a wireless access point, a base station (BS), a subscriber station (SS), a mobile subscriber center (MSC), a radio network controller (RNC), a microprocessor, an integrated circuit such as an application specific integrated circuit (ASIC), a programmable logic device (PLD), a processor such as general purpose processor, a digital signal processor (DSP) and/or a network processor, an interface, an input/output (I/O) device (e.g., keyboard, mouse, display, printer), a router, a hub, a gateway, a bridge, a switch, a circuit, a logic gate, a register, a semiconductor device, a chip, a transistor, or any other device, machine, tool, equipment, component, or combination thereof. The embodiments are not limited in this context.

In various embodiments, a node may comprise, or be implemented as, software, a software module, an application, a program, a subroutine, an instruction set, computing code, words, values, symbols or combination thereof. A node may be implemented according to a predefined computer language, manner or syntax, for instructing a processor to perform a certain function. Examples of a computer language may include C, C++, Java, BASIC, Perl, Matlab, Pascal, Visual BASIC, assembly language, machine code, micro-code for a processor, and so forth. The embodiments are not limited in this context.

In various embodiments, the communications system 100 may communicate, manage, or process information in accordance with one or more protocols. A protocol may comprise a set of predefined rules or instructions for managing communication among nodes. A protocol may be defined by one or more standards as promulgated by a standards organization, such as, the International Telecommunications Union (ITU), the International Organization for Standardization (ISO), the International Electrotechnical Commission (IEC), the Institute of Electrical and Electronics Engineers (IEEE), the Internet Engineering Task Force (IETF), the Motion Picture Experts Group (MPEG), and so forth. For example, the described embodiments may be arranged to operate in accordance with standards for media processing, such as the National Television System Committee (NTSC) standard, the Phase Alteration by Line (PAL) standard, the MPEG-1 standard, the MPEG-2 standard, the MPEG-4 standard, the Digital Video Broadcasting Terrestrial (DVB-T) broadcasting standard, the ITU/IEC H.263 standard, Video Coding for Low Bitrate Communication, ITU-T Recommendation H.263v3, published November 2000 and/or the ITU/IEC H.264 standard, Video Coding for Very Low Bit Rate Communication, ITU-T Recommendation H.264, published May 2003, and so forth. The embodiments are not limited in this context.

In various embodiments, the nodes of system 100 may be arranged to communicate, manage or process different types of information, such as media information and control information. Examples of media information may generally include any data representing content meant for a user, such as voice information, video information, audio information, image information, textual information, numerical information, alphanumeric symbols, graphics, and so forth. Control information may refer to any data representing commands, instructions or control words meant for an automated system. For example, control information may be used to route media information through a system, to establish a connection between devices, instruct a node to process the media information in a predetermined manner, and so forth. The embodiments are not limited in this context.

In various embodiments, system 100 may be implemented as a wired communication system, a wireless communication system, or a combination of both. Although system 100 may be illustrated using a particular communications media by way of example, it may be appreciated that the principles and techniques discussed herein may be implemented using any type of communication media and accompanying technology. The embodiments are not limited in this context.

When implemented as a wired system, for example, system 100 may include one or more nodes arranged to communicate information over one or more wired communications media. Examples of wired communications media may include a wire, cable, printed circuit board (PCB), backplane, switch fabric, semiconductor material, twisted-pair wire, co-axial cable, fiber optics, and so forth. The wired communications media may be connected to a node using an input/output (I/O) adapter. The I/O adapter may be arranged to operate with any suitable technique for controlling information signals between nodes using a desired set of communications protocols, services or operating procedures. The I/O adapter may also include the appropriate physical connectors to connect the I/O adapter with a corresponding communications medium. Examples of an I/O adapter may include a network interface, a network interface card (NIC), disc controller, video controller, audio controller, and so forth. The embodiments are not limited in this context.

When implemented as a wireless system, for example, system 100 may include one or more wireless nodes arranged to communicate information over one or more types of wireless communication media. An example of wireless communication media may include portions of a wireless spectrum, such as the RF spectrum in general, and the ultra-high frequency (UHF) spectrum in particular. The wireless nodes may include components and interfaces suitable for communicating information signals over the designated wireless spectrum, such as one or more antennas, wireless transmitters/receivers (“transceivers”), amplifiers, filters, control logic, antennas, and so forth. The embodiments are not limited in this context.

In various embodiments, system 100 may comprise a media processing system having one or more media source nodes 102-1-n. Media source nodes 102-1-n may comprise any media source capable of sourcing or delivering media information and/or control information to media processing node 106. More particularly, media source nodes 102-1-n may comprise any media source capable of sourcing or delivering digital audio and/or video (AV) signals to media processing node 106. Examples of media source nodes 102-1-n may include any hardware or software element capable of storing and/or delivering media information, such as a Digital Versatile Disk (DVD) device, a Video Home System (VHS) device, a digital VHS device, a personal video recorder, a computer, a gaming console, a Compact Disc (CD) player, computer-readable or machine-readable memory, a digital camera, camcorder, video surveillance system, teleconferencing system, telephone system, medical and measuring instruments, scanner system, copier system, and so forth. Other examples of media source nodes 102-1-n may include media distribution systems to provide broadcast or streaming analog or digital AV signals to media processing node 106. Examples of media distribution systems may include, for example, Over The Air (OTA) broadcast systems, terrestrial cable systems (CATV), satellite broadcast systems, and so forth. It is worthy to note that media source nodes 102-1-n may be internal or external to media processing node 106, depending upon a given implementation. The embodiments are not limited in this context.

In various embodiments, the incoming video signals received from media source nodes 102-1-n may have a native format, sometimes referred to as a visual resolution format. Examples of a visual resolution format include a digital television (DTV) format, high definition television (HDTV), progressive format, computer display formats, and so forth. For example, the media information may be encoded with a vertical resolution format ranging between 480 visible lines per frame to 1080 visible lines per frame, and a horizontal resolution format ranging between 640 visible pixels per line to 1920 visible pixels per line. In one embodiment, for example, the media information may be encoded in an HDTV video signal having a visual resolution format of 720 progressive (720 p), which refers to 720 vertical pixels and 1280 horizontal pixels (720×1280). In another example, the media information may have a visual resolution format corresponding to various computer display formats, such as a video graphics array (VGA) format resolution (640×480), an extended graphics array (XGA) format resolution (1024×768), a super XGA (SXGA) format resolution (1280×1024), an ultra XGA (UXGA) format resolution (1600×1200), and so forth. The embodiments are not limited in this context.

In various embodiments, media processing system 100 may comprise a media processing node 106 to connect to media source nodes 102-1-n over one or more communications media 104-1-m. Media processing node 106 may comprise any node as previously described that is arranged to process media information received from media source nodes 102-1-n. In various embodiments, media processing node 106 may comprise, or be implemented as, one or more media processing devices having a processing system, a processing sub-system, a processor, a computer, a device, an encoder, a decoder, a coder/decoder (CODEC), a filtering device (e.g., graphic scaling device, deblocking filtering device), a transformation device, an entertainment system, a display, or any other processing architecture. The embodiments are not limited in this context.

In various embodiments, media processing node 106 may include a media processing sub-system 108. Media processing sub-system 108 may comprise a processor, memory, and application hardware and/or software arranged to process media information received from media source nodes 102-1-n. For example, media processing sub-system 108 may be arranged to vary a contrast level of an image or picture and perform other media processing operations as described in more detail below. Media processing sub-system 108 may output the processed media information to a display 110. The embodiments are not limited in this context.

In various embodiments, media processing node 106 may include a display 110. Display 110 may be any display capable of displaying media information received from media source nodes 102-1-n. Display 110 may display the media information at a given format resolution. For example, display 110 may display the media information on a display having a VGA format resolution, XGA format resolution, SXGA format resolution, UXGA format resolution, and so forth. The type of displays and format resolutions may vary in accordance with a given set of design or performance constraints, and the embodiments are not limited in this context.

In general operation, media processing node 106 may receive media information from one or more of media source nodes 102-1-n. For example, media processing node 106 may receive media information from a media source node 102-1 implemented as a DVD player integrated with media processing node 106. Media processing sub-system 108 may retrieve the media information from the DVD player, convert the media information from the visual resolution format to the display resolution format of display 110, and reproduce the media information using display 110.

In various embodiments, media processing node 106 may be arranged to receive an input image from one or more of media source nodes 102-1-n. The input image may comprise any data or media information derived from or associated with one or more video images. In various embodiments, the input image may comprise one or more of image data, video data, video sequences, groups of pictures, pictures, images, regions, objects, frames, slices, macroblocks, blocks, pixels, signals, and so forth. The values assigned to pixels may comprise real numbers and/or integer numbers.

In various embodiments, media processing node 106 may be arranged to receive a decoded picture frame or a plurality of decoded picture frames and to selectively output and selectively buffer the frames. For example, the media processing note may output the decoded picture frame or frames according to the display order of the frame or frames. More particularly, the media processing node 106 may be arranged provide a fast buffering path versus the decoding process of H.264 for those picture frames for which the POC equals 2. For a frame for which the POC equals 2, the decoded frame is immediately output (e.g., to display 110) without first being stored in the DPB (and waiting for the DPB to be full). Thereafter, the decoded frame is only stored in the DPB if it is a reference frame.

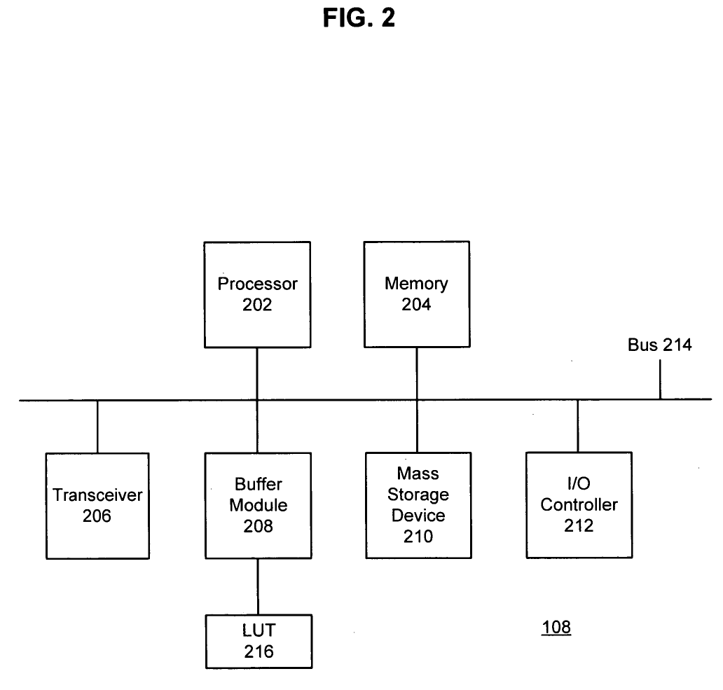

In one embodiment, for example, media processing sub-system 108 of media processing node 106 may be arranged to receive a decoded picture frame or a plurality of decoded picture frames and to selectively output and selectively buffer the decoded frames. For example, the media-processing sub-system 108 may output the decoded frame or frames immediately (e.g., to display 110) if the POC of the decoded frame equals 2. The media processing sub-system 108 of media processing node 106 may further be arranged to thereafter store the decoded frame in the DPB if it is a reference frame. Media processing sub-system 108 may utilize one or more pre-defined or predetermined mathematical functions to control the output (e.g., to the display 110) and buffer (e.g., the DPB) path and/or sequence of a decoded frame or frames to improve system 100 performance. System 100 in general, and media processing sub-system 108 in particular, may be described in more detail with reference to FIG. 2.

FIG. 2 illustrates one embodiment of a media processing sub-system 108. FIG. 2 illustrates a block diagram of a media processing sub-system 108 suitable for use with media processing node 106 as described with reference to FIG. 1. The embodiments are not limited, however, to the example given in FIG. 2.

As shown in FIG. 2, media processing sub-system 108 may comprise multiple elements. One or more elements may be implemented using one or more circuits, components, registers, processors, software subroutines, modules, or any combination thereof, as desired for a given set of design or performance constraints. Although FIG. 2 shows a limited number of elements in a certain topology by way of example, it can be appreciated that more or less elements in any suitable topology may be used in media processing sub-system 108 as desired for a given implementation. The embodiments are not limited in this context.

In various embodiments, media processing sub-system 108 may include a processor 202. Processor 202 may be implemented using any processor or logic device, such as a complex instruction set computer (CISC) microprocessor, a reduced instruction set computing (RISC) microprocessor, a very long instruction word (VLIW) microprocessor, a processor implementing a combination of instruction sets, or other processor device. In one embodiment, for example, processor 202 may be implemented as a general purpose processor, such as a processor made by Intel® Corporation, Santa Clara, Calif. Processor 202 may also be implemented as a dedicated processor, such as a controller, microcontroller, embedded processor, a digital signal processor (DSP), a network processor, a media processor, an input/output (I/O) processor, a media access control (MAC) processor, a radio baseband processor, a field programmable gate array (FPGA), a programmable logic device (PLD), and so forth. The embodiments are not limited in this context.

In one embodiment, media processing sub-system 108 may include a memory 204 to couple to processor 202. Memory 204 may be coupled to processor 202 via communications bus 214, or by a dedicated communications bus between processor 202 and memory 204, as desired for a given implementation. Memory 204 may be implemented using any machine-readable or computer-readable media capable of storing data, including both volatile and non-volatile memory. For example, memory 204 may include read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, or any other type of media suitable for storing information. It is worthy to note that some portion or all of memory 204 may be included on the same integrated circuit as processor 202, or alternatively some portion or all of memory 204 may be disposed on an integrated circuit or other medium, for example a hard disk drive, that is external to the integrated circuit of processor 202. The embodiments are not limited in this context.

In various embodiments, media processing sub-system 108 may include a transceiver 206. Transceiver 206 may be any radio transmitter and/or receiver arranged to operate in accordance with a desired wireless protocols. Examples of suitable wireless protocols may include various wireless local area network (WLAN) protocols, including the IEEE 802.xx series of protocols, such as IEEE 802.11a/b/g/n, IEEE 802.16, IEEE 802.20, and so forth. Other examples of wireless protocols may include various wireless wide area network (WWAN) protocols, such as Global System for Mobile Communications (GSM) cellular radiotelephone system protocols with General Packet Radio Service (GPRS), Code Division Multiple Access (CDMA) cellular radiotelephone communication systems with 1×RTT, Enhanced Data Rates for Global Evolution (EDGE) systems, and so forth. Further examples of wireless protocols may include wireless personal area network (PAN) protocols, such as an Infrared protocol, a protocol from the Bluetooth Special Interest Group (SIG) series of protocols, including Bluetooth Specification versions v1.0, v1.1, v1.2, v2.0, v2.0 with Enhanced Data Rate (EDR), as well as one or more Bluetooth Profiles (collectively referred to herein as “Bluetooth Specification”), and so forth. Other suitable protocols may include Ultra Wide Band (UWB), Digital Office (DO), Digital Home, Trusted Platform Module (TPM), ZigBee, and other protocols. The embodiments are not limited in this context.

In various embodiments, media processing sub-system 108 may include one or more modules. The modules may comprise, or be implemented as, one or more systems, sub-systems, processors, devices, machines, tools, components, circuits, registers, applications, programs, subroutines, or any combination thereof, as desired for a given set of design or performance constraints. The embodiments are not limited in this context.

In one embodiment, for example, media processing sub-system 108 may include a buffer module 208. Buffer module 208 may be used to coordinate the sequence and buffering of a decoded picture frame or frames as introduced above according to predetermined mathematical functions or algorithms. For example, the predetermined mathematical functions or algorithms may be stored in any suitable storage device, such as memory 204, a mass storage device (MSD) 210, a hardware-implemented lookup table (LUT) 216, and so forth. It may be appreciated that buffer module 208 may be implemented as software executed by processor 202, dedicated hardware, or a combination of both. The embodiments are not limited in this context.

In various embodiments, media processing sub-system 108 may include a MSD 210. Examples of MSD 210 may include a hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of DVD devices, a tape device, a cassette device, or the like. The embodiments are not limited in this context.

In various embodiments, media processing sub-system 108 may include one or more I/O adapters 212. Examples of I/O adapters 212 may include Universal Serial Bus (USB) ports/adapters, IEEE 1394 Firewire ports/adapters, and so forth. The embodiments are not limited in this context.

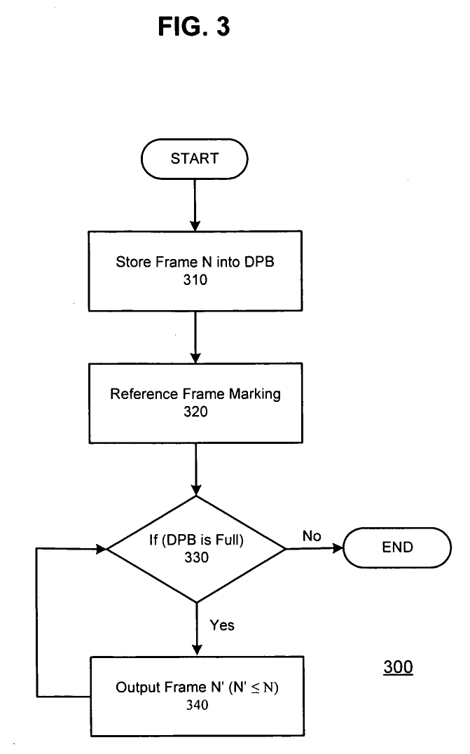

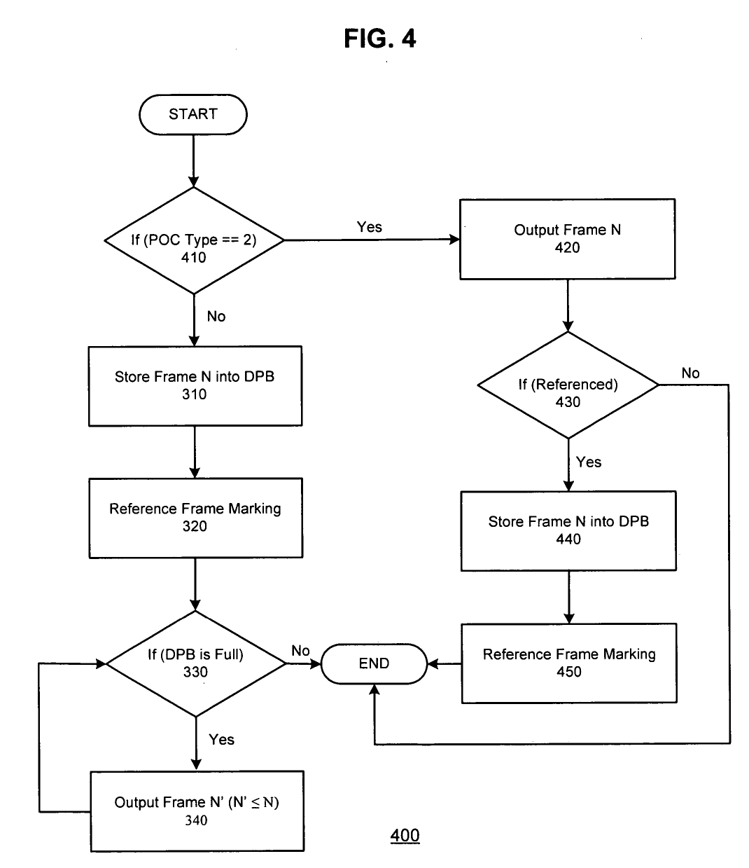

In general operation, media processing sub-system 108 may receive media information from one or more media source nodes 102-1-n. For example, media source node 102-1 may comprise a DVD device connected to processor 202. Alternatively, media source 102-2 may comprise memory 204 storing a digital AV file, such as a motion pictures expert group (MPEG) encoded AV file. The buffer module 208 may operate to receive the media information from mass storage device 216 and/or memory 204, process the media information (e.g., via processor 202), and store or buffer the media information on memory 204, the cache memory of processor 202, or a combination thereof. The operation of the me buffer module 208 may be understood with reference to the logic flows of FIGS. 3 and 4.

FIG. 3 illustrates a logic flow 300 of the H.264 decoding standard. In contrast to other video coding standards, the order of the decoding process according to the H.264 standard is generally not the same as the order of the source picture capture process at the encoder or the output order from the decoder for display (e.g., on display 110). The choice may be delegated to the encoder dependent on the application requirements without any specific constraints dictated by H.264 standard. In other words, the encoding order (decoding order at the decoder) and source capture order (display order at the decoder) depends on the encoder's decision according to a specific application requirement. To prevent displaying the decoded frames out of order, a decoded picture buffer (DPB) according to the H.264 Annex C hypothetical reference decoder (HRD) may be adopted in a H.264 video decoder.

More specifically, logic flow 300 illustrates at 310 that a decoded frame is first stored in the DPB. Thereafter, at 320 the frame is marked if it is a reference frame. At 330 it is determined whether or not the DPB is full. If the DPB is full, the stored decoded frames are output (e.g., to display 110) according to their POC until one non-referenced frame is displayed and can be removed from the DPB. Alternatively, provided the DPB is full, the stored decoded frames will continue to be output (e.g., to display 110). If the DPB is not full, the output of the decoded frames ends until incoming decoded frames, stored into the DPB at 310, again fill the DPB.

The decoded frame output buffering process of the logic flow 300 H.264 video decoder requires memory resources and incurs output and corresponding display delay based on the decoded picture buffer size. The DPB size is specified in video usability information (VUI) parameters of the H.264 standard in Annex E. When VUI is not present in the stream, DPB size may be inferred in units of frame buffers using, for example, the following equation:
DPB size=Min(1024*MaxDPB/(PicWidthInMbs*FrameHeightInMbs*256*ChromaFormatFactor), 16)

For the above equation, MaxDPB is a variable specified in Table A-1 Level limits, H.264 standard Annex A. Accordingly, for a given resolution and Chroma Format Factor, the DPB size can be calculated as illustrated by Table 1. Table 1 further illustrates the delay (in frames) between when a decoded frame is first stored in the DPB at 310 and when it is output at 340 (e.g., to display 110).

TABLE 1

| | | | Chroma | | | | | Max Delay |
|---|---|---|---|---|---|---|---|---|
| | Width | Height | Format | | MaxDPB | DPB size | Delay | Time |
| Resolution | (MB) | (MB) | Factor | Level | (Kbytes) | (KBytes) | (frames) | @24 fps (s) |
| QCIF | 11 | 9 | 1.5 | 1 | 148.5 | 148.5 | 4 | 0.17 s |
| QCIF | 11 | 9 | 1.5 | 2 | 891.0 | 594.0 | 16 | 0.67 s |
| CIF | 22 | 18 | 1.5 | 2 | 891.0 | 891.0 | 6 | 0.25 s |
| QCIF | 11 | 9 | 1.5 | 3 | 3037.5 | 594.0 | 16 | 0.67 s |
| CIF | 22 | 18 | 1.5 | 3 | 3037.5 | 2376.0 | 16 | 0.67 s |
| 625 SD | 40 | 36 | 1.5 | 3 | 3037.5 | 3037.5 | 5 | 0.21 s |

Table 1 may illustrate DPB size under different resolution and levels. Accordingly, Table 1 demonstrates that the H.264 HRD decoded picture buffering illustrated by logic flow 300 creates a significant memory requirement and output delay. The large memory requirement moreover may impede the application of advanced memory management technologies, such as allocating key buffers in on-chip fast SRAM, locking frame buffers into level-1 or level-2 caches, and other such memory management schemes. For instance, the Intel® XScale-based PXA27x application processor has a 256 KByte on-chip SRAM and an Intel® XScale®-based forthcoming application processor platform includes a 256 KByte L2 cache and 768 KByte SRAM to accelerate the application. However, the application of the memory management schemes introduced above may offer little performance improvement to the H.264 decoding illustrated by logic flow 300 since the enhanced memory resources utilized by each memory management scheme cannot fully meet the large memory requirement of the H.264 decoding.

FIG. 4 illustrates logic flow 400 of an embodiment. As noted above, certain H.264 decoded frames are output in ascending POC according to the decoding process specified in chapter 8.2.1 of the H.264 standard. In particular, the decoded frames are output in ascending POC if they are POC type 2 decoded frames.

More specifically, logic flow 400 of an embodiment illustrates an alternate buffering path and sequence when POC type equals 2 for an incoming decoded frame. For POC type 2, the output order (POC) of each frame is proportional to its display order (frame number). Formulas 8-12 through 8-14 in H.264 standard further elaborate the proportionality. Generally speaking, for POC type 2, the earlier one frame is decoded, the earlier it will be output (e.g., to display 110). Based on the proportionality between the decoding timing and output timing for POC type 2 frames, the output process for the POC type 2 decoded frames may be simplified.

For example, and as illustrated by logic flow 300, at 410 it is determined whether or not an incoming decoded frame is a POC type 2 frame. If the incoming decoded frame is not POC type 2, the processes 310-340 apply. If the incoming decoded frame is a POC type 2 frame, the decoded frame is output (e.g., to display 110) at 420 with no frame delay. Thereafter, at 430 it is determined whether or not the decoded frame will be referenced by following decoded frames. If the decoded frame will be referenced by decoded frames that follow, the decoded frame is stored in the DPB at 440. The decoded frame stored in the DPB is thereafter marked as a reference frame at 450. Alternatively, if it is determined that a decoded frame is not a reference frame, it will not be stored in the DPB.

As noted, the logic flow 400 of an embodiment enables a fast buffering path for decoded frames if they are POC type 2 decoded frames. The fast buffering path of an embodiment offers at least two improvements versus the H.264 standard of logic flow 300. First, based on not buffering the POC type 2 decoded frames unless they are reference frames, an embodiment reduces the maximum buffer size required by a particular picture resolution. Further, as the POC type 2 decoded frames are output (e.g., to display 110) before they are stored in the DPB buffer (if at all depending on whether they are reference frames), there is no frame delay between the decoding and the output. Table 2 illustrates the difference between the logic flow 300 and logic flow 400 of an embodiment for a POC type 2 frame further assuming that the number of reference frames is 1 (it is a typical case to have one reference number).

TABLE 2

| | | FIG. 3 DPB | | FIG. 4 DPB | |
|---|---|---|---|---|---|
| | | Buffer size | Delay | Buffer size | Delay |
| Resolution | Level | (KBytes) | (frames) | (KBytes) | (frames) |
| QCIF | 1 | 148.5 | 4 | 37.125 | 0 |
| QCIF | 2 | 594.0 | 16 | 37.125 | 0 |
| CIF | 2 | 891.0 | 6 | 148.5 | 0 |
| QCIF | 3 | 594.0 | 16 | 37.125 | 0 |
| CIF | 3 | 2376.0 | 16 | 148.5 | 0 |
| 625 SD | 3 | 3037.5 | 5 | 607.5 | 0 |

As shown above, Table 2 may illustrate H.264 HRD DPB versus DPB of an embodiment (e.g., delay and buffer size).

The reduction in DPB size according to an embodiment further may allow the application of advanced memory management technologies in H.264 decoders as introduced above. The advanced memory management technologies in turn increase the performance of the decoder. For example for a given processor capacity, the decoder may be capable of a higher frame rate (i.e., frames per second). Alternatively, and of particular import to mobile embedded platforms, for a given frame rate, an embodiment may reduce a processor capacity requirement. This may, for example, be reflected in reduced power consumption for a given frame rate.

In particular, the following tables demonstrate the performance improvement by adoption of particular advanced memory management technologies for the logic flow 300 approach versus logic flow 400 of an embodiment. The tests were performed on a Monahans-P platform comprising an Intel® XScale®-based application processor including a 256 KByte L2 cache and 768 KByte SRAM. Table 3 illustrates the performance improvement by allocating key buffers in on-chip SRAM and Table 4 illustrates the performance improvement by locking frame buffers in L2 cache.

TABLE 3

| Key buffers in | | | SRAM |
|---|---|---|---|
| on-chip SRAM | Improvement | Improvement | Consumed (KB) |
| Akiyo (QCIF, 40 kbps) | 2.50% | 24.69% | 150 |
| Foreman | 0.80% | 10.75% | 150 |
| (QCIF, 128 kbps) | | | |
| Akiyo (CIF, 128 kbps) | 2.62% | 25.36% | 478 |
| Foreman (CIF, 384 kbps) | 0.22% | 8.84% | 478 |
| Foreman | 0.17% | 6.57% | 523 |
| (VGA, 1.5 Mbps) | | | |

TABLE 4

| | | | L2 Locked |
|---|---|---|---|
| L2 Locking | Improvement | Improvement | size (KByte) |
| Akiyo (CIF, 40 kbps) | 0.41% | 8.30% | 149 |
| Foreman | 0.01% | 2.10% | 149 |
| (CIF, 128 kbps) | | | |

As demonstrated by Table 3 and Table 4, the logic flow 400 of an embodiment offers improved performance for each advanced memory management technology.

Further, an embodiment is straightforward to implement in the H.264 standard. Compared with H.264 decoder illustrated by logic flow 300, the implementation of an embodiment detailed below adds a fast buffering path in the DPB management function to handle streams whose constituent frames are POC type 2. The following code or similar adds the fast buffering path of an embodiment as illustrated by logic flow 400. For the following code, hOut is the output handle (e.g., a display device handle, output file pointer, etc.), pCurFrame is the pointer to the newly decoded frame, pFrameList is the decoded frame list stored in the DPB for display and reference use later, and pMMCO points to the structure containing memory management control operation types and values used in reference picture marking process.

```
/* when a new frame is decoded */
    If (pCurFrame->nPocType == 2) {
        OutputFrame(pCurFrame, hOut);
            pCurFrame->bDisplayed = TRUE;
            if (pCurFrame->bReferenced == TRUE) {
                InsertFrameToBuffer(pCurFrame, pFrameList);
                RefPicListMark(pFrameList, pMMCO);
        }
    }
```

Generally speaking, the code first detects if the new decoded frame is a POC type 2 frame. If yes, the new decoded frame is output without delay. It is then determined if the new decoded frame will be referenced by frame that follow. If yes, the new decoded frame is inserted into the DPB buffer and marked as a reference frame.

Numerous specific details have been set forth herein to provide a thorough understanding of the embodiments. It will be understood by those skilled in the art, however, that the embodiments may be practiced without these specific details. In other instances, well-known operations, components and circuits have not been described in detail so as not to obscure the embodiments. It can be appreciated that the specific structural and functional details disclosed herein may be representative and do not necessarily limit the scope of the embodiments.

It is also worthy to note that any reference to “one embodiment” or “an embodiment” means that a particular feature, structure, or characteristic described in connection with the embodiment is included in at least one embodiment. The appearances of the phrase “in one embodiment” in various places in the specification are not necessarily all referring to the same embodiment.

Some embodiments may be implemented using an architecture that may vary in accordance with any number of factors, such as desired computational rate, power levels, heat tolerances, processing cycle budget, input data rates, output data rates, memory resources, data bus speeds and other performance constraints. For example, an embodiment may be implemented using software executed by a general-purpose or special-purpose processor. In another example, an embodiment may be implemented as dedicated hardware, such as a circuit, an application specific integrated circuit (ASIC), Programmable Logic Device (PLD) or digital signal processor (DSP), and so forth. In yet another example, an embodiment may be implemented by any combination of programmed general-purpose computer components and custom hardware components. The embodiments are not limited in this context.

Some embodiments may be described using the expression “coupled” and “connected” along with their derivatives. It should be understood that these terms are not intended as synonyms for each other. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

Some embodiments may be implemented, for example, using a machine-readable medium or article which may store an instruction or a set of instructions that, if executed by a machine, may cause the machine to perform a method and/or operations in accordance with the embodiments. Such a machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions may include any suitable type of code, such as source code, compiled code, interpreted code, executable code, static code, dynamic code, and the like. The instructions may be implemented using any suitable high-level, low-level, object-oriented, visual, compiled and/or interpreted programming language, such as C, C++, Java, BASIC, Perl, Matlab, Pascal, Visual BASIC, assembly language, machine code, and so forth. The embodiments are not limited in this context.

Unless specifically stated otherwise, it may be appreciated that terms such as “processing,” “computing,” “calculating,” “determining,” or the like, refer to the action and/or processes of a computer or computing system, or similar electronic computing device, that manipulates and/or transforms data represented as physical quantities (e.g., electronic) within the computing system's registers and/or memories into other data similarly represented as physical quantities within the computing system's memories, registers or other such information storage, transmission or display devices. The embodiments are not limited in this context.

While certain features of the embodiments have been illustrated as described herein, many modifications, substitutions, changes and equivalents will now occur to those skilled in the art. It is therefore to be understood that the appended claims are intended to cover all such modifications and changes as fall within the true spirit of the embodiments.

What is claimed is:

1. An apparatus comprising:
a media processing node to receive a decoded video frame, the media processing node to selectively output and selectively buffer the decoded video frame.

2. The apparatus of claim 1, the media processing node to include a buffer module, the buffer module to
determine if the decoded video frame has a picture order count equal to 2; and
output the decoded video frame if the video frame has a picture order count equal to 2.

3. The apparatus of claim 2, the buffer module to further
determine if the decoded video frame having a picture order count equal to 2 is a reference frame.

4. The apparatus of claim 3, the buffer module to further
store the decoded video frame having a picture order count equal to 2 in a decoded picture buffer if the decoded video frame is a reference frame.

5. The apparatus of claim 4, the buffer module to further
mark the decoded video frame as a reference frame.

6. A system comprising:
a communications medium; and
a media processing node to receive a decoded video frame, the media processing node to selectively output and selectively buffer the decoded video frame.

7. The system of claim 6, the media processing node to include a buffer module, the buffer module to
determine if the decoded video frame has a picture order count equal to 2; and
output the decoded video frame if the video frame has a picture order count equal to 2.

8. The system of claim 7, the buffer module to further
determine if the decoded video frame having a picture order count equal to 2 is a reference frame.

9. The system of claim 8, the buffer module to further
store the decoded video frame having a picture order count equal to 2 in a decoded picture buffer if the decoded video frame is a reference frame.

10. The system of claim 9, the buffer module to further
mark the decoded video frame as a reference frame.

11. A method comprising:
determining if a decoded video frame has a picture order count equal to 2; and
outputting the decoded video frame if the video frame has a picture order count equal to 2.

12. The method of claim 11, outputting the decoded video frame if the video frame has a picture order count equal to 2 further comprising:
outputting the decoded video frame without a frame delay.

13. The method of claim 12 further comprising:
determining if the decoded video frame is a reference frame.

14. The method of claim 13 further comprising:
storing the decoded video frame in a decoded picture buffer if the decoded video frame is a reference frame.

15. The method of claim 14 further comprising:
marking the decoded video frame as a reference frame.

16. An article comprising a machine-readable storage medium containing instructions that if executed enable a system to:
determine if a decoded video frame has a picture order count equal to 2; and output
the decoded video frame if the video frame has a picture order count equal to 2.

17. The article of claim 16 further comprising instructions that if executed enable the system to:
output the decoded video frame without a frame delay.

18. The article of claim 17, further comprising instructions that if executed enable the system to:
determine if the decoded video frame is a reference frame.

19. The article of claim 18 further comprising instructions that if executed enable the system to:
store the decoded video frame in a decoded picture buffer if the decoded video frame is a reference frame.

20. The article of claim 19, further comprising instructions that if executed enable the system to:
mark the decoded video frame as a reference frame.
